(19) United States
(12) Patent Application Publication
(10) Pub. No.: US 2004/0041314 A1
(43) Pub. Date: Mar. 4, 2004

(54) Air-spring system

(76) Inventor: Cord Luhmann, Buxtehude (DE)

Correspondence Address: WILLIAM COLLARD, COLLARD & ROE, P.C., 1077 NORTHERN BOULEVARD, ROSLYN, NY, 11576, US

(21) Appl. No.: 10/344,652

(22) PCT Filed: May 31, 2002
(86) PCT No.: PCT/DE02/02004

(30) Foreign Application Priority Data
Jun. 15, 2001 (DE) 10128679.1

(51) Int. Cl. F16F 9/04

(52) U.S. Cl. 267/64.24; 267/122

(57) ABSTRACT

The invention relates to an air-spring system (1), which is at least comprised of a cover (2), a roll-off plunger (3) and air-spring bellows (4) that are made of an elastomeric material and that are in most cases provided with an embedded stabilizing support, the two bellows ends being fastened to the cover and to the roll-off plunger, whereby the air-spring bellows enclose a volume-elastic air chamber while forming two loops (7, 8). The first loop (7) is adapted to glide on the outer wall of the roll-off plunger (3) and the second loop (8) communicates with a roll-off section of the cover (2). The inventive air-spring system (1) is further characterized in that the second loop (8) rests on the cover (2) only on two points (11) and rolls off via said points of support (11) when the angle of the air spring bellows (4) is modified by the deflection and the rebound of the roll-off plunger (3).

The invention relates to an air spring system that is at least comprised of a cover, a roll-off plunger and an air spring bellows that is made of an elastomeric material and provided with an embedded reinforcement in most cases, whereby the two ends of the bellows are secured on the cover, on the one hand, and the roll-off plunger on the other, so that the air spring bellows encloses an air chamber with an elastic volume; and whereby, furthermore, the air spring bellows is forming two loops, namely

a first loop that is adapted to slide along the outer wall of the roll-off plunger, and

a second loop that communicates with a roll-off section of the cover.

An air spring system of the type specified above (short designation: “pneumatic spring”) with a double-loop construction is in particular known in the automotive field of application. Reference is made in this connection in particular to the following published patent documents: DE 198 42 733 A1; DE 100 50 028 A1; DE 101 03 493 A1; WO 00/77417 A1; and U.S. Pat. No. 3,876,193.

This type of construction can be realized in this connection for both the axial bellows (DE 36 43 073 A1) as well as the bellows with crossed layers (DE 29 04 522 A1), whereby it is preferred to employ an external guide when an axial bellows is used.

The pneumatic springs have to produce the axle-specific cardanic property by mans of the axle in which the air springs according to the prior art are installed. One of the components of the construction, the roll-off plunger or the cover, is secured on the body in a stationary manner. The other component is connected with the guide rod (tie-up to the undercarriage) of the axle in a fixed manner. A change in the angle and spacing in relation to the fixed component takes place as reflection and rebound processes take place.

The construction principle according to the prior art permits only minor adjustments of the angle. Either a component collision will occur, the air spring bellows will buckle outwards or inwards, or pressure stresses will occur in the reinforcement of the bellows that are damaging to the useful life.

The problem of the invention is to provide an air spring that permits higher angle adjustments without outward buckling, collision with construction components, or build-up of pressure stresses in the reinforcement, namely subject to the proviso that an air spring can be installed substantially deeper in the axle, and that higher requirements resulting therefrom with respect to the cardanic property are satisfied.

This problem is resolved in that the second loop rests on the cover only on two points, and rolls off via the points of support when changes in the angle of the air spring bellows occur due to the deflection and the rebound of the roll-off plunger.

In the most favorable case, the second loop comes will come to rest on the cover with respect to the support points only in the positions of maximal deflection and rebound.

Furthermore, owing to the fact that no pressure stresses occur in the air spring bellows within the area of the cover due to this novel type of construction, transverse forces resulting from such forces are prevented from occurring as well. The decrease of transverse forces results in a decreasing load on the suspension elements of the components of the axle and thus ensues also an improvement of the driving comfort.

In a system of the air spring with a guide element as an additional component, for example a shock absorber (DE 100 50 028 A1), the reduction of the transverse forces results in a decrease of the resulting forces of friction in the sealing and contact elements.

Now, the invention is explained with the help of an exemplified embodiment and by reference to schematic drawings. In the drawings,

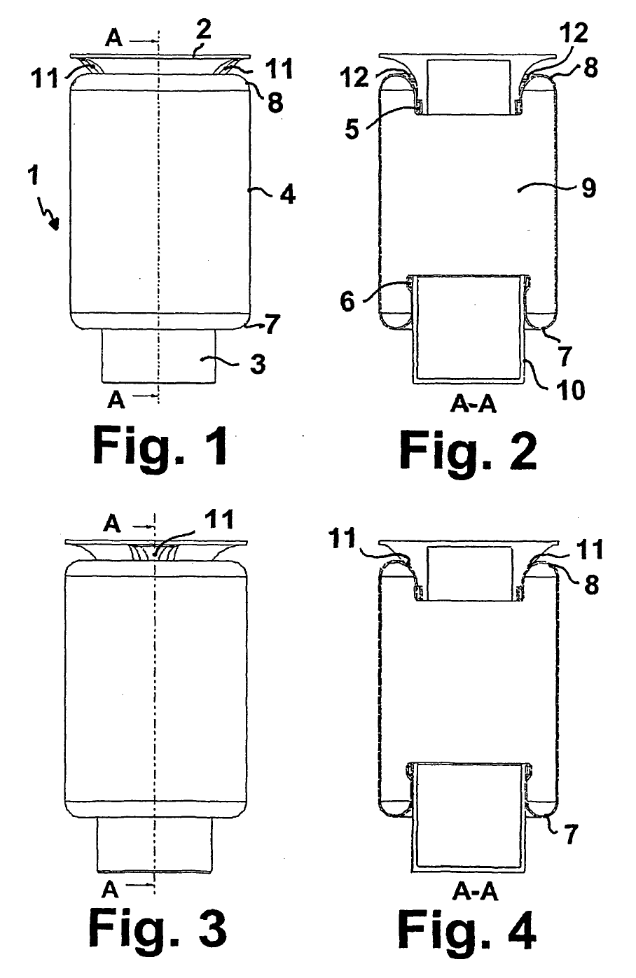

FIG. 1 is a representation of a double-loop construction, whereby the second loop rests on two points of support;

FIG. 2 is a representation of a double-loop construction according to section line A-A (FIG. 1);

FIG. 3 is a representation that is turned by 90° versus the double-loop construction according to FIG. 1;

FIG. 4 is a representation of a double-lop construction according to section line A-A (FIG. 3).

FIG. 1 shows an air spring system 1 with the important basic components, namely the air spring bellows 4, the cover 2, and the roll-off plunger 3. The cover, which is secured on the body in a stationary manner, may be realized in the form of a pressure container, in conjunction with a valve, if need be (DE 198 19 642 A1). The roll-off plunger is connected with the guide rod of the axle in a fixed manner.

During deflection and rebounding processes, the first loop 7 is rolling along the outer wall 10 of the roll-off plunger, whereby reference is made in particular to FIG. 2.

According to the prior art, the second loop 8 of the air spring bellows is corresponding all around with the roll-off area of the cover. Consequently the roll-off area has the function of a roll-off surface that has a curved (concave) shape in most cases. Conical surfaces (DE 101 03 493 A1) are common as well.

As opposed to the flat roll-off concept according to the prior art, in the present case, the second loop 8 is resting on the cover 2 only on the two points 11. When the angle of the air spring bellows is changing due to the deflection and rebound of the roll-off plunger, the second loop is rolling off via the support points 11. The two support points are arranged with the same spacing from one another especially in the peripheral direction of the cover.

The support points 11 are formed by a contouring of the cover 2 in particular in the form of a stepped contouring, whereby reference is made in that regard especially to FIG. 3.

As opposed to FIG. 4, the area of the second lop 8 is shown in FIG. 2 without any contact of support with the cover 2.

The concept as defined by the invention, with the two support points 11 for the second loop 8, applies as well to an air spring system in which the roll-off plunger as the upper component is connected with the body in a stationary manner, whereas the cover as the lower component is then connected with the guide rod of the axle (WO 00/77417 A1).

List of Reference Numerals

1 Air spring system

2 Cover (pressure container)

3 Roll-off plunger (immersion plunger)

4 Air spring bellows

5 End of bellows with fastening on the cover by means of a clamping ring

6 End of bellows with fastening on the roll-off plunger by means of a clamping ring

7 First loop (rolling fold)

8 Second loop. (rolling fold)

9 Air chamber with elastic volume

10 Outer wall (roll-off surface) of the roll-off plunger

11 Support point for the second loop

12 Area of the second loop without support contact with the cover.

1. An air spring system (1) at least comprised of a cover (2), a roll-off plunger (3) and an air spring bellows (4) made of elastomeric material and provided with an embedded reinforcement in most cases, whereby the two ends (5, 6) of the bellows are secured on the over, on the one hand, and on the roll-off plunger on the other, causing the air spring bellows to enclose an air chamber (9) with an elastic volume; and whereby, furthermore, the air spring bellows is forming two loops (7, 8), namely
a first loop (7) adapted to slide along the outer wall (10) of the roll-off plunger (3); as well as
a second loop (8) connected with a roll-off area of the cover (2);
characterized in that
the second loop (8) rests on the cover (2) only in two points (11) and rolls-off via the support points (11) when the angle of the air spring bellows (4) is changing due to deflection and rebound of the roll-off plunger (3).

2. The air spring system according to claim 1, characterized in that the support points (11) are formed by a contouring of the cover (2).

3. The air spring system according to claim 2, characterized in that the support points (11) are formed by a stepped contouring of the cover (2).

4. The air spring system according to any one of claims 1 to 3, characterized in that the two support points (11) are arranged with the same spacing from each other in the peripheral direction of the cover (2).

5. The air spring system according to any one of claims 1 to 4, characterized in that the second loop (8) comes to rest on the cover (2) only in the maximal positions of deflection and rebound.
